(19) United States
(12) Patent Application Publication
(10) Pub. No.: US 2012/0252231 A1
(43) Pub. Date: Oct. 4, 2012

(54) MAGNETIC CONNECTOR SYSTEM

(76) Inventor: Magnus Kall, Espoo (FI)

(21) Appl. No.: 13/405,538

(22) Filed: Feb. 27, 2012

(30) Foreign Application Priority Data
Feb. 28, 2011 (EP) 11156120.5

(51) Int. Cl. H01R 11/30

(52) U.S. Cl. 439/39

(57) ABSTRACT

A magnetic connector system comprising a first connector part having at least one contact and at least one magnetic element and a second connector part having at least one contact and at least one magnetic element, wherein the magnetic elements of the connector parts are arranged to create an attractive force to keep the contacts of the connector parts engaged when the connector parts are proximally located, wherein there is a pivot point at an edge area of the first connector part and the second connector part, the pivot point being located between the first connector part and the second connector part when the connector parts are engaged, and wherein the first connector part and/or the second connector part are arranged to turn around the pivot point when the first connector part and the second connector part are disconnected from each other by a non-axial force.

### BACKGROUND OF THE INVENTION

1. Field of the Invention

Embodiments of the present invention relate to connector systems used in different technical fields and devices, i.e. the connector system may be a part of an electrical system, hydraulic system or pneumatic system for example.

2. Description of the Prior Art

A large number of customer complaints relating to supplies and accessories are related to connector wear and ultimately connector failure. One reason for connector failures is that significant force is sometimes required to disconnect a pair of connector parts. This can result in mechanical damage to the contacts if the connection is opened improperly, for example, when the connection is bent opened instead of properly pull opened.

Another issue causing connector failures is improper alignment of the connector parts prior to engagement. If the connector parts are not properly aligned during application, there is a large risk that some or all contacts of the connector, for example connector pins, are bent or pushed into the connector frame.

The connector parts used in the prior art are very often male-female connectors, i.e. the connector parts remain in connecting position with the aid of friction between the male and female part. This structure often leads to the problems discussed above.

In order to overcome the problems above magnetic connectors have been developed. Said magnetic connectors are based on the use of the attractive force created by magnetic elements, i.e. the connector parts are kept together in connecting position by using a force created by magnetic elements. The embodiments used in the prior art are mainly from the computer world, i.e. the construction described is used mainly in connection with laptop computers, especially in connection with supplying power to a laptop computer from a transformer connected to an AC power supply. The idea in said embodiments is that the first connector part detaches from the second connector part if a strong force inadvertently acts on the connector parts. This may happen for example if the user moves the laptop too much and too rapidly or if someone stumbles on the power cord. Rather than breaking, the connector parts detach from one another despite the fact that a fairly strong and sudden non-axial force is acting on the connector.

The problems are however quite different in other fields, such as in a hospital environment. Connectors used in hospital environments have different issues relating to connecting, disconnecting and reconnecting steps. For example, in hospital environments it is essential that connector parts are not disconnected inadvertently, i.e. the attracting force between the connector parts must be great, and that the connector parts may still be easily disengaged. Another issue common to hospital environments is that all sensors/cables are not compatible with all devices although the same connector type is used (e.g. sensors from different manufacturers are compatible with a subset of available device ports). To prevent incompatible sensors/cables from being connected to a specific device, a keying scheme is used to prevent connection of an incompatible sensor/cable. In the prior art, this keying consist of a set of mechanical notches and grooves that enable connection when the notches and grooves are aligned, but prevent connection when the notches and grooves are not aligned.

### BRIEF SUMMARY OF THE INVENTION

According to an embodiment of the present invention, there is provided a magnetic connector system, the system comprising a first connector part having at least one contact and at least one magnetic element and a second connector part having at least one contact and at least one magnetic element, wherein the at least one magnetic element of the first connector part and the at least one magnetic element of the second connector part are arranged to create an attractive force to keep the at least one contact of the first connector part and the at least one contact of the second connector part engaged when the first connector part and the second connector part are proximally located, wherein there is a pivot point at an edge area of the first connector part and the second connector part, the pivot point being located between the first connector part and the second connector part when the first connector part and the second connector part are engaged, and wherein the first connector part and/or the second connector part are arranged to turn around the pivot point when the first connector part and the second connector part are disconnected from each other by a non-axial force.

According to another embodiment of the present invention, there is provided a magnetic connector system, the system comprising a first connector part having at least one contact and at least one magnetic element and a second connector part having at least one contact and at least one magnetic element, wherein the at least one magnetic element of the first connector part and the at least one magnetic element of the second connector part are arranged to create an attractive force to keep the at least one contact of the first connector part and the at least one contact of the second connector part engaged when the first connector part and the second connector part are proximally located, wherein there is a pivot point at an edge area of the first connector part and the second connector part, the pivot point being located between the first connector part and the second connector part when the first connector part and the second connector part are engaged, wherein the first connector part or/and the second connector part are arranged to turn around the pivot point when the first connector part and the second connector part are disconnected from each other by a non-axial force, and wherein one of the connector parts is a part of a connection element.

According to another embodiment of the present invention, there is provided a magnetic connector system, the system comprising a first connector part having at least one contact and at least one magnetic element and a second connector part having at least one contact and at least one magnetic element, wherein the at least one magnetic element of the first connector part and the at least one magnetic element of the second connector part arranged to create an attractive force to keep the at least one contact of the first connector part and the at least one contact of the second connector part engaged when the first connector part and the second connector part are proximally located, wherein there is a pivot point at an edge area of the first connector part and the second connector part, the pivot point being located between the first connector part and the second connector part when the first connector part and the second connector part are engaged, wherein the first connector part or/and the second connector part are arranged to turn around the pivot point when the first connector part and the second connector part are disconnected from each other by a non-axial force, and wherein one of the first connector part and the second connector part are embedded to a casing of a device.

### BRIEF DESCRIPTION OF THE DRAWINGS

Other features, objects and advantages of the present invention will become apparent from the following description, which is purely an illustration and not a limitation, and which should be read with reference to the appended drawings, wherein:

FIG. 1 shows a schematic view of a connector system in accordance with an embodiment of the present invention;

FIG. 2 shows the system of FIG. 1 seen in another orientation in accordance with an embodiment of the present invention;

FIG. 3 shows the basic principle of disengaging of the systems shown in FIGS. 1 and 2 in accordance with an embodiment of the present invention;

FIG. 4 shows a schematic view of the movement trajectory of the parts of a system during disengaging in accordance with an embodiment of the present invention;

FIG. 5 shows a schematic view of a pneumatic or hydraulic connector system in accordance with an embodiment of the present invention;

FIG. 6 shows a schematic view of a connector system using electromagnets in accordance with an embodiment of the present invention;

FIG. 7 shows a schematic view of a keying scheme in accordance with an embodiment of the present invention; and

FIG. 8 shows a schematic view of a keying scheme in accordance with an embodiment of the present invention.

### DETAILED DESCRIPTION OF THE INVENTION

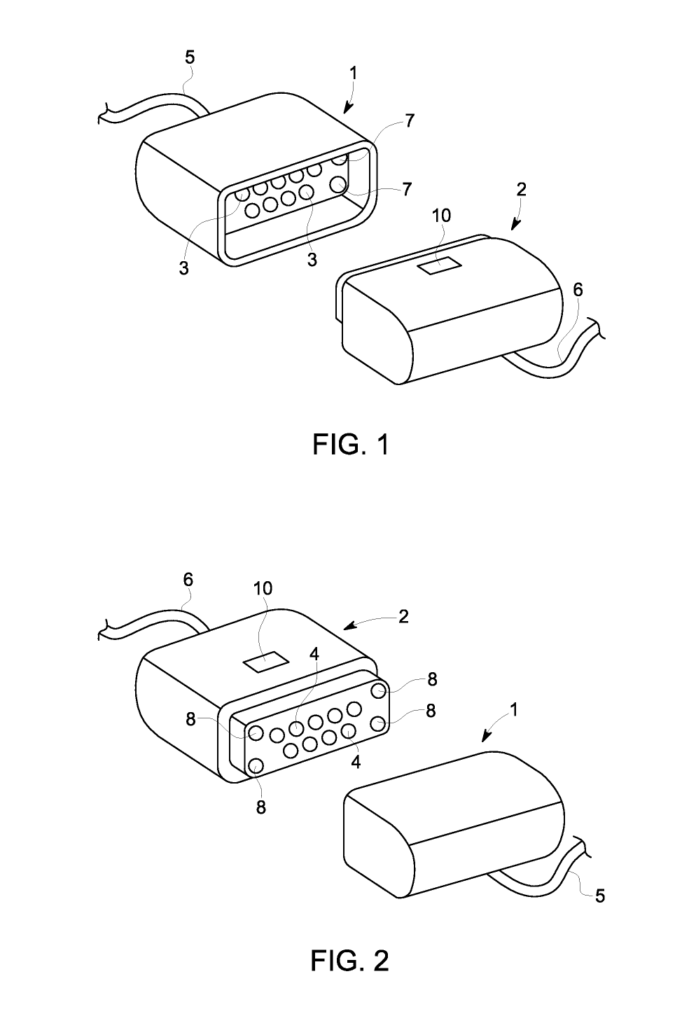

FIGS. 1 and 2 show a schematic view of embodiments of a magnetic connector system. Reference number 1 shows a first connector part and reference number 2 shows a second connector part. Reference numbers 3 and 4 show contacts in the first and second connector parts 1, 2. The amount of contacts 3, 4 may vary freely according to the existing need.

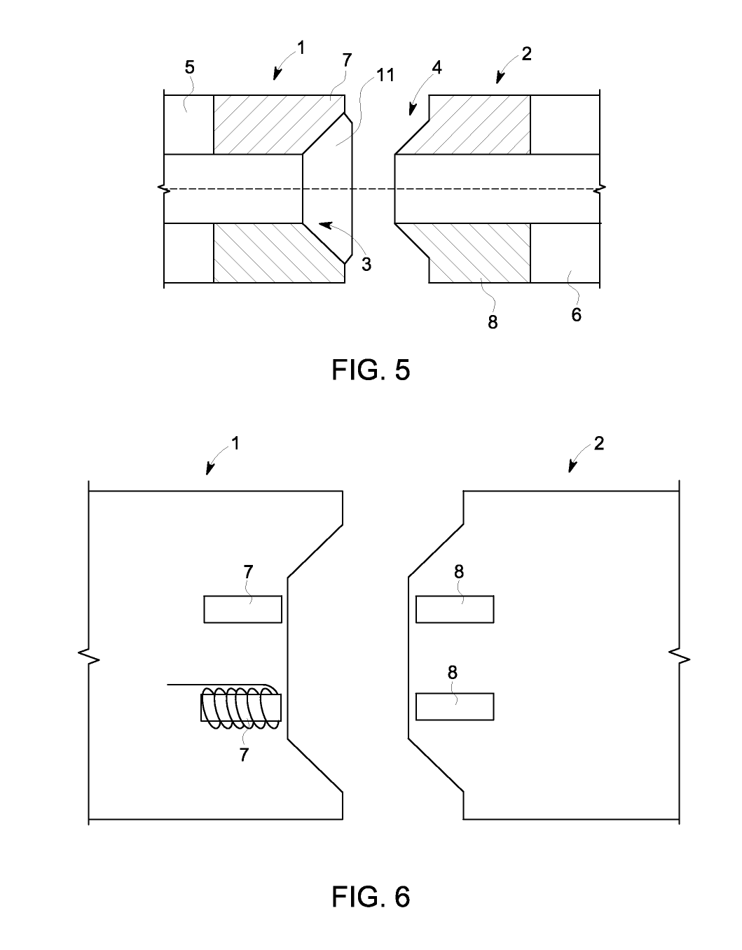

The embodiment illustrated in FIGS. 1 and 2 is an electrical connector, i.e. contacts 3, 4 are electrical contacts. Reference numbers 5 and 6 in FIGS. 1 and 2 show schematically connecting elements, for example electric cables connected to the first connector part 1 and to the second connector part 2. It must however be understood that FIGS. 1 and 2 show only a non-limiting example of an embodiment of the present invention. In other embodiments, it is possible that the first connector part 1 is embedded into a casing of any appropriate device, for example an electrical device, etc. It must be understood further that electrical connection is not the only possibility. It is also possible to utilize the construction shown in connection with hydraulic or pneumatic applications as shown in FIG. 5. For example, cable 6 shown here must be understood only as a non-limiting example. In other embodiments, instead of the cable, a pneumatic or hydraulic pipeline can be used. The contacts 3 and 4 shown in FIGS. 1 and 2 must be understood only as a nonlimiting example. In other embodiments, appropriate pneumatic or hydraulic connectors may be used if the construction shown is used in connection with pneumatic or hydraulic applications.

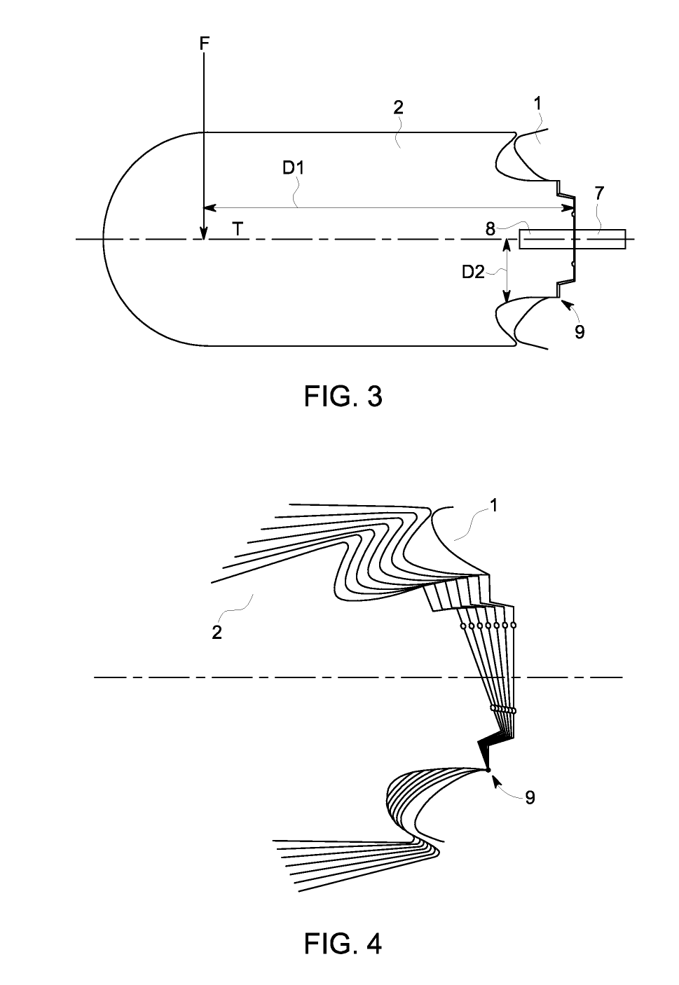

The embodiment shown in FIGS. 1 and 2 provides a connector system in which the first connector part 1 can be easily inserted into the second connector part 2. The first connector part 1 can be either a female part or a male part, etc. The connector parts 1, 2 are guided into place by magnetic elements 7, 8. The magnetic elements 7, 8 are arranged to create an attractive force to keep the connectors engaged in a connecting state when the first and the second connector parts 1, 2 are proximally located. The geometry of the connector parts 1, 2 is chosen so that the contacts 3, 4, in the embodiment of FIGS. 1 and 2 comprise pins and sockets which can engage without significant friction to each other. These matters are clearly shown in FIGS. 3 and 4.

The connector parts 1, 2 can be disengaged by means of bending the connection. The connection can be made to have a very large axial retention force, but still enable disconnection through a small or moderate bending force. The phrase bending means that a non axial-force is created to bend, and thereby, to disengage the connection. The basic principle is schematically shown in FIG. 3 in which the non-axial force discussed above is marked with a reference F. The axial retention force discussed above is created by magnetic elements 7, 8.

The first connector part 1 and the second connector part 2 are formed so that there is a pivot point 9 at the edge area of the first connector part 1 and the second connector part 2. The pivot point 9 is located between the first connector part 1 and the second connector part 2 when the connector parts are engaged to each other to form the connecting state. The term pivot point must be interpreted widely in this disclosure, depending on the geometry of the connector parts, the pivot point can either be a point or an axis. The first connector part 1 and/or the second connector part 2 is/are arranged to turn around the pivot point 9 when the connector parts 1, 2 are disconnected from each other by using a non-axial force F.

FIG. 4 schematically shows the movement trajectory of the connector parts 1, 2 during disengaging, i.e. in the situation where force F shown in FIG. 3 acts on the connector part 2.

The first connector part 1 and/or the second connector part 2 may be formed as an oblong parts/oblong part to obtain an appropriate torque arm for creating the non-axial force. Said matter is illustrated in FIG. 3. FIG. 3 shows how bending the connector parts generates a significantly larger disengaging force than pulling the connector parts apart. Distance D1, i.e. torque arm, is approximately six times longer than distance D2 resulting in a separation force at the magnetic elements 7, 8 which is six times greater compared to the bending force applied to the connector parts. Utilizing this principle, the axial retention force can be made significantly larger compared to a connector designed to be axially disengaged.

The magnetic elements 7, 8 can be permanent magnets or electromagnets. FIG. 6 shows an embodiment using electromagnets. In different embodiments, one, several, or all of the magnetic elements used can be electromagnets. Magnetic elements 7, 8 may also comprise ferromagnetic elements acting together with, for example, permanent magnets. The term magnetic elements covers further rare earth magnets, for example, neodymium magnets and the like. The amount and location of the magnetic elements 7, 8 may vary according to the existing need. It is also possible to adjust the attractive force by placing the magnetic elements appropriately so that the non-axial force needed for disengaging the connector parts is adjusted in appropriate directions.

As described above, magnetic elements 7, 8 are used to hold the first connector part 1 and the second connector part 2 together with a well-controlled retention force. It should be understood that it is possible to create a powerful axial retention force by using magnetic elements and it is still possible to disengage the contact by using moderate non-axial bending force F with appropriate torque arm as shown in FIG. 3.

FIG. 5 shows an embodiment of the present invention in hydraulic or pneumatic applications. Reference number 11 shows a conical gasket. The magnetic force keeps the conical male connector part 2 pressed against the conical gasket 11 in the conical female connector part 1 forming a gas/liquid tight seal. FIG. 5 also shows gas/liquid flow pipes 5, 6.

By using the magnetic elements 7, 8 it is also possible to provide a means for creating a keying scheme which will actually cause non-compatible connector parts 1, 2 to be repelled from each other. For example, in a case of a device or an interconnect connector, the magnetic elements in the connector parts can be electromagnets rather than permanent magnets. This allows for active control of the keying through the use of an appropriate memory element inside the accessory/cable being connected to the connector part. Said memory element is shown schematically with a reference number 10 in FIGS. 1 and 2. The term memory element should be interpreted widely. In different embodiments, the memory element can be for example a memory chip, a resistor, a simple short or a set of shorts, etc. Once the memory element 10, for example, a memory chip, is read, the device determines if the cable/accessory is valid. If it is not valid, the polarity of the electromagnets can be reversed, pushing the cable/accessory connector part, for example, the second connector part 2, out of the co-acting connector part, for example, the first connector part 1.

A combination of permanent magnets and electromagnets may also be used to provide limited retention when the device is not powered on.

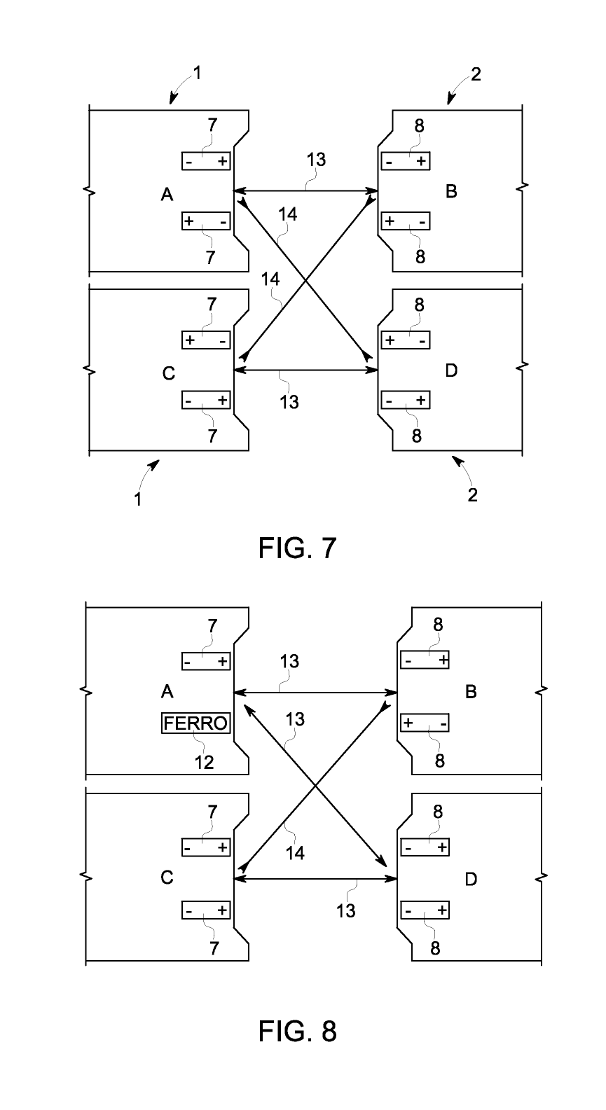

In an embodiment, it is further possible to use variable polarity in at least one magnetic element to create a keying scheme where, for example, one combination of male and female connector parts are attracted and another combination of male and female connector parts are repelled so that only a subset of available sensors can be connected to a particular device or cable. To create a keying scheme with permanent magnets, one or more of the magnets in the connector parts are made changeable. Changeability means that several versions of the connector parts exist, each with its own combination of permanent magnet polarities. By using a combination of permanent magnets 7, 8 and elements made of ferromagnetic material 12, it is possible to create a receptacle, for example, a first connector part that can accept two types of second connector parts and another receptacle, or a first connector part that can only accept one of two second connector parts. FIGS. 7 and 8 show schematically the matters described above. FIG. 7 shows an exclusive keying scheme for the first connector parts 1, 2. FIG. 8 shows a non-exclusive keying scheme for the first and the second connector parts 1, 2. Arrows 13 illustrate attracting forces and arrows 14 illustrate repellent forces.

Electromagnets can also be used to reject a sensor or a cable that has failed a diagnostics check. For example, if the device concludes through sensor diagnostics that a sensor has a failure, such as an electrical short, the electromagnetic connector can be used to eject the failed sensor.

A connector system in accordance with different embodiments discussed above allows disengagement through bending. The system enables the axial retention force to differ significantly from the bending force required to intentionally disconnect the connector. Magnetic keying is more robust than mechanical keying, since the system uses electromagnets, a keying scheme can be updated through software update of the device.

This written description uses examples to disclose the present invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A magnetic connector system comprising:
a first connector part having at least one contact and at least one magnetic element; and
a second connector part having at least one contact and at least one magnetic element,
wherein the at least one magnetic element of the first connector part and the at least one magnetic element of the second connector part are arranged to create an attractive force to keep the at least one contact of the first connector part and the at least one contact of the second connector part engaged when the first connector part and the second connector part are proximally located, wherein there is a pivot point at an edge area of the first connector part and the second connector part, the pivot point being located between the first connector part and the second connector part when the first connector part and the second connector part are engaged, and wherein the first connector part and/or the second connector part are arranged to turn around the pivot point when the first connector part and the second connector part are disconnected from each other by a non-axial force.

2. The magnetic connector system according to claim 1, wherein the geometry of the first connector part and the second connector part is chosen so that the at least one contact of the first connector part and the at least one contact of the second connector part engage without significant friction to each other.

3. The magnetic connector system according to claim 1, wherein the first connector part is one of a male and a female connector part and the second connector part is the other of a male and female connector part.

4. The magnetic connector system according to claim 1, wherein the first connector part and/or the second connector part are formed as an oblong part to obtain an appropriate torque arm for creating the non-axial force.

5. The magnetic connector system according to claim 1, wherein the at least one magnetic element of the first connector part and the at least one magnetic element of the second connector part comprise permanent magnets.

6. The magnetic connector system according to claim 1, wherein the at least one magnetic element of the first connector part and the at least one magnetic element of the second connector part comprise electromagnets.

7. The magnetic connector system according to claim 1, wherein the at least one magnetic element of the first connector part and the at least one magnetic element of the second connector part comprise ferromagnetic elements.

8. The magnetic connector system according to claim 5, wherein polarity in the at least one magnetic element of the first connector part and/or the at least one magnetic element of the second connector part is made changeable.

9. The magnetic connector system according to claim 6, wherein polarity in the at least one magnetic element of the first connector part and/or the at least one magnetic element of the second connector part is made reversible.

10. The magnetic connector system according to claim 1, wherein the at least one magnetic element of the first connector part and the at least one magnetic element of the second connector part are configured to create a keying scheme.

11. The magnetic connector system according to claim 10, wherein the at least one magnetic element of the first connector part and the at least one magnetic element of the second connector part are configured to operate with a memory element.

12. The magnetic connector system according to claim 1, wherein the at least one contact of the first connector part and the at least one contact of the second connector part are electrical contacts.

13. The magnetic connector system according to claim 1, wherein the at least one contact of the first connector part and the at least one contact of the second connector part are hydraulic or pneumatic contacts that create a gas/liquid tight seal.

14. A magnetic connector system comprising:
a first connector part having at least one contact and at least one magnetic element; and
a second connector part having at least one contact and at least one magnetic element,
wherein the at least one magnetic element of the first connector part and the at least one magnetic element of the second connector part are arranged to create an attractive force to keep the at least one contact of the first connector part and the at least one contact of the second connector part engaged when the first connector part and the second connector part are proximally located, wherein there is a pivot point at an edge area of the first connector part and the second connector part, the pivot point being located between the first connector part and the second connector part when the first connector part and the second connector part are engaged, wherein the first connector part or/and the second connector part are arranged to turn around the pivot point when the first connector part and the second connector part are disconnected from each other by a non-axial force, and wherein one of the connector parts is a part of a connection element.

15. A magnetic connector system comprising:
a first connector part having at least one contact and at least one magnetic element; and
a second connector part having at least one contact and at least one magnetic element,
wherein the at least one magnetic element of the first connector part and the at least one magnetic element of the second connector part arranged to create an attractive force to keep the at least one contact of the first connector part and the at least one contact of the second connector part engaged when the first connector part and the second connector part are proximally located, wherein there is a pivot point at an edge area of the first connector part and the second connector part, the pivot point being located between the first connector part and the second connector part when the first connector part and the second connector part are engaged, wherein the first connector part or/and the second connector part are arranged to turn around the pivot point when the first connector part and the second connector part are disconnected from each other by a non-axial force, and wherein one of the first connector part and the second connector part are embedded to a casing of a device.

16. The magnetic connector system according to claim 14, wherein the geometry of the first connector part and the second connector part is chosen so that the at least one contact of the first connector part and the at least one contact of the second connector part engage without significant friction to each other.

17. The magnetic connector system according to claim 14, wherein the first connector part is one of a male and a female connector part and the second connector part is the other of a male and female connector part.

18. The magnetic connector system according to claim 14, wherein the first connector part and/or the second connector part are formed as an oblong part to obtain an appropriate torque arm for creating the non-axial force.

19. The magnetic connector system according to claim 14, wherein the at least one magnetic element of the first connector part and the at least one magnetic element of the second connector part comprise permanent magnets, or permanent magnets and ferromagnetic elements.

20. The magnetic connector system according to claim 14, wherein the at least one magnetic element of the first connector part and the at least one magnetic element of the second connector part comprise electromagnets.
